(19) United States
(12) Patent Application Publication
(10) Pub. No.: US 2023/0169311 A1
(43) Pub. Date: Jun. 1, 2023

(54) OBTAINING AN AUTOENCODER MODEL FOR THE PURPOSE OF PROCESSING METRICS OF A TARGET SYSTEM

(71) Applicant: Elisa Oyj, Helsinki (FI)

(72) Inventors: Rasmus HEIKKILÄ, Helsinki (FI); Antti LISKI, Helsinki (FI)

(73) Assignee: Elisa Oyj, Helsinki (FI)

(21) Appl. No.: 17/921,033

(22) PCT Filed: Apr. 23, 2021
(86) PCT No.: PCT/FI2021/050307

§ 371 Date: Oct. 24, 2022

(30) Foreign Application Priority Data
Apr. 28, 2020 (FI) 20205426

(51) Int. Cl. G06N 3/0455; G06N 3/08; H04L 41/16

(52) U.S. Cl. CPC G06N 3/0455; G06N 3/08; H04L 41/16

(57) ABSTRACT

A computer implemented method for obtaining an autoencoder model for the purpose of processing metrics of a target system. The method includes obtaining a data set including metrics associated with the target system, the data set being intended for training the autoencoder for processing further metrics of the target system; masking the data set with a predefined mask configured to exclude certain parts of the data set; using the unmasked parts of the data set for training the autoencoder; masking reconstructed data from the autoencoder with the same predefined mask; using reconstruction error of the unmasked parts of the reconstructed data to update parameters of the autoencoder to obtain autoencoder model; using the masked parts of the data set for testing the autoencoder model; and providing the autoencoder model for processing further metrics of the target system.

### TECHNICAL FIELD

The present application generally relates to obtaining an autoencoder model for the purpose of processing metrics of a target system.

### BACKGROUND

This section illustrates useful background information without admission of any technique described herein representative of the state of the art.

Autoencoders are a class of neural networks that learn to efficiently capture the structure of data in an unsupervised manner. An autoencoder consists of an encoder and a decoder, both of which are neural networks. The encoder side aims to learn latent (or reduced) representation of the original sample and the decoder side tries to reconstruct the original sample from the latent representation.

The networks of an autoencoder are trained using a backpropagation algorithm, which computes the gradient of a loss function with respect to the model parameters. The gradient computation is performed efficiently by proceeding from the last layer of the network towards the first layer and using the gradients of the previous layers in computing the gradient of the current layer by applying the chain rule.

The loss function used in training an autoencoder is some differentiable function of the reconstruction error of the samples, such as the mean squared error.

Cross-validation is a method that can be used for assessing performance of a statistical model on an independent data set, while making efficient use of all available data for training the model. In k-fold cross-validation, the data set is divided into k folds. The model is trained on k-1 folds and one of the folds is left as a test set to be used for evaluating the model. The evaluation is performed by calculating a test metric on the test set. When each fold is used as the test set once, k values of the test metric are obtained.

Model selection is the task of choosing, from a set of candidate models, the model that provides the best representation of the data. The set of candidate models can contain different types of models, or models of the same type that are configured with e.g. different hyperparameters or trained with different loss functions. A hyperparameter is a parameter whose value is set before the model is trained and evaluated.

Cross-validation can be used to perform the model selection. The cross-validation procedure is repeated for different sets of hyperparameters, and the test metric values are used for choosing the best model.

Hyperparameter optimization is a special case of model selection, where the candidate models belong to the same family of models but have different hyperparameters. In consequence, cross-validation can be used to perform hyperparameter optimization. There exist various methods for choosing the different sets of hyperparameters for evaluation, including grid search, random search and Bayesian optimization.

In supervised learning, applying cross-validation is straightforward: a feature matrix X and a target vector y can be partitioned by the rows into k folds. In other words, the pairs consisting of a feature vector and a target are partitioned into k sets.

In unsupervised learning involving autoencoders, we have only the feature matrix X and no target vector y. Partitioning cannot be performed by the rows of X, because the same row would then act as the predictor and the target, making them dependent. No dimensionality reduction at all would trivially achieve the best reconstruction. For this reason, cross-validation is not easily applied to unsupervised learning.

In unsupervised learning involving autoencoders, training of the neural network model typically involves choosing how many latent dimensions to model. The number of latent dimensions is a hyperparameter. With too few dimensions, not all relationships will be captured in the model (underfitting), and using too many dimensions results in modeling of noise (overfitting).

U.S. Pat. No. 9,406,017 teaches training of neural network, wherein randomly (or pseudorandomly) selected subset of feature detectors are selectively disabled to reduce overfitting. In such solution there exists the problem of choosing the probability of disabling a feature detector, which can be seen as a hyperparameter.

### SUMMARY

Various aspects of examples of the invention are set out in the claims. Any devices and/or methods in the description and/or drawings which are not covered by the claims are examples useful for understanding the invention.

According to a first example aspect of the present invention, there is provided a computer implemented method for obtaining an autoencoder model for the purpose of processing metrics of a target system. The method comprises
obtaining a data set comprising metrics associated with the target system, the data set being intended for training the autoencoder for processing further metrics of the target system;
masking the data set with a predefined mask configured to exclude certain parts of the data set;
using the unmasked parts of the data set for training the autoencoder;
masking reconstructed data from the autoencoder with the same predefined mask;
using reconstruction error of the unmasked parts of the reconstructed data to update parameters of the autoencoder to obtain autoencoder model;
using the masked parts of the data set for testing the autoencoder model; and providing the autoencoder model for processing further metrics of the target system.

In an example embodiment, the target system is an industrial process. In an example embodiment, the data set comprises sensor data from the industrial process.

In an example embodiment, the target system is a communication network. In an example embodiment, the data set comprises performance metrics from the communication network.

In an example embodiment, the method further comprises providing the autoencoder model for the purpose of controlling the target system.

In an example embodiment, the predefined mask is a regular mask. In another example embodiment, the predefined mask is a random mask.

In an example embodiment, the method further comprises using the method for performing autoencoder model selection by cross-validation.

In an example embodiment, using the method for performing autoencoder model selection by cross-validation comprises performing the method with k different predefined masks to perform k-fold cross-validation.

In an example embodiment, the method further comprises using the method for selecting hyperparameters for the autoencoder model.

According to a second example aspect of the present invention, there is provided an apparatus comprising a processor and a memory including computer program code; the memory and the computer program code configured to, with the processor, cause the apparatus to perform the method of the first aspect or any related embodiment.

According to a third example aspect of the present invention, there is provided a computer program comprising computer executable program code which when executed by a processor causes an apparatus to perform the method of the first aspect or any related embodiment.

The computer program of the third aspect may be a computer program product stored on a non-transitory memory medium.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows an example scenario according to an embodiment;

FIG. 2 shows an apparatus according to an embodiment;

FIG. 3 shows a flow diagram illustrating example methods according to certain embodiments; and

FIG. 4 illustrates some example implementations.

### DETAILED DESCRIPTION OF THE DRAWINGS

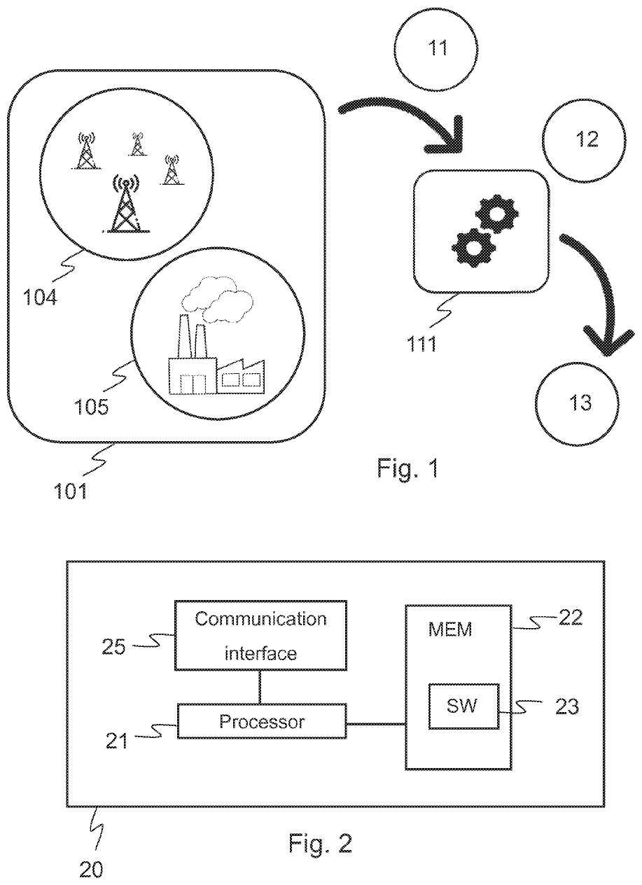

Example embodiments of the present invention and its potential advantages are understood by referring to FIGS. 1 through 4 of the drawings. In this document, like reference signs denote like parts or steps.

Certain example embodiments of the invention aim at obtaining an autoencoder model with optimal hyperparameters determined by cross-validation. That is, at least some example embodiments provide cross-validation usable in unsupervised learning. Embodiments of the invention and autoencoder arrangements provided in various embodiments can be used in the context of processing metrics from industrial processes or communication networks. Processing results may be used for management of the industrial processes or communication networks. The autoencoder model obtained by the methods of various embodiments may be used for anomaly detection to detect abnormalities in measurement or performance metrics of a target system. Corrective actions or other management actions (such as changing parameters, replacing components, restarting devices, issuing alarms etc.) can then be performed based on the results of the detected abnormalities.

FIG. 1 shows an example scenario according to an embodiment. The scenario shows a target system 101 and an automation system 111 configured to implement processing of metrics from the target system according to example embodiments. The target system 101 may be a communication network 104 comprising a plurality of physical network sites comprising base stations and other network devices, or the target system 101 may be an industrial process 105 such as a factory or a manufacturing process.

In an embodiment of the invention the scenario of FIG. 1 operates as follows: In phase 11, the automation system 111 receives data from the target system 101. The data may be received directly from the target system or through some intermediary system or storage. In general, the data may concern for example measurement results or performance metrics from the target system 101.

In phase 12, the automation system 111 processes the data.

In phase 13, the automation system 111 outputs results of the processing phase. This output may then be used as a basis for processing and analyzing further data from the target system and/or for further actions for example in management of or changes in the target system 101.

FIG. 2 shows an apparatus 20 according to an embodiment. The apparatus 20 is for example a general-purpose computer or server or some other electronic data processing apparatus. The apparatus 20 can be used for implementing embodiments of the invention. That is, with suitable configuration the apparatus 20 is suited for operating for example as the automation system 111 of foregoing disclosure.

The general structure of the apparatus 20 comprises a processor 21, and a memory 22 coupled to the processor 21. The apparatus 20 further comprises software 23 stored in the memory 22 and operable to be loaded into and executed in the processor 21. The software 23 may comprise one or more software modules and can be in the form of a computer program product. Further, the apparatus 20 comprises a communication interface 25 coupled to the processor 21.

The processor 21 may comprise, e.g., a central processing unit (CPU), a microprocessor, a digital signal processor (DSP), a graphics processing unit, or the like. FIG. 2 shows one processor 21, but the apparatus 20 may comprise a plurality of processors.

The memory 22 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 20 may comprise a plurality of memories.

The communication interface 25 may comprise communication modules that implement data transmission to and from the apparatus 20. The communication modules may comprise, e.g., a wireless or a wired interface module. The wireless interface may comprise such as a WLAN, Bluetooth, infrared (IR), radio frequency identification (RF ID), GSM/GPRS, CDMA, WCDMA, LTE (Long Term Evolution) or 5G radio module. The wired interface may comprise such as Ethernet or universal serial bus (USB), for example. Further the apparatus 20 may comprise a user interface (not shown) for providing interaction with a user of the apparatus. The user interface may comprise a display and a keyboard, for example. The user interaction may be implemented through the communication interface 25, too.

A skilled person appreciates that in addition to the elements shown in FIG. 2, the apparatus 20 may comprise other elements, such as displays, as well as additional circuitry such as memory chips, application-specific integrated circuits (ASIC), other processing circuitry for specific purposes and the like. Further, it is noted that only one apparatus is shown in FIG. 2, but the embodiments of the invention may equally be implemented in a cluster of shown apparatuses.

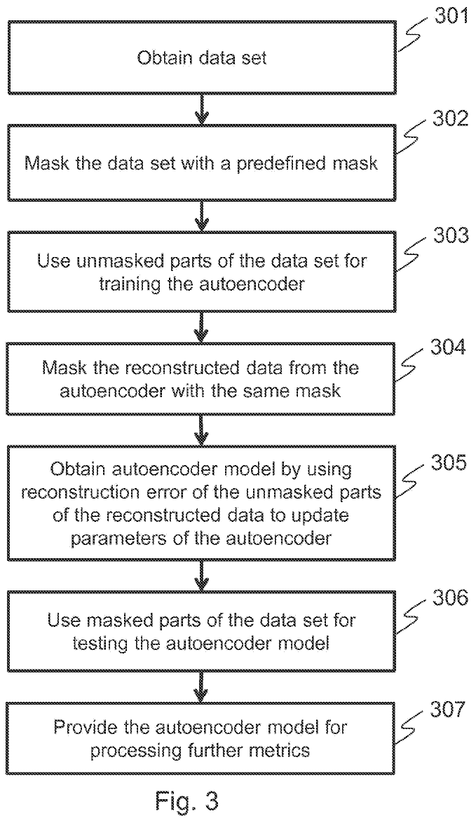

FIG. 3 shows a flow diagram illustrating example methods according to certain embodiments. The methods may be implemented in the automation system 111 of FIG. 1 and/or in the apparatus 20 of FIG. 2. The methods are implemented in a computer and do not require human interaction unless otherwise expressly stated. It is to be noted that the methods may however provide output that may be further processed by humans and/or the methods may require user input to start. Different phases shown in FIG. 3 may be combined with each other and the order of phases may be changed except where otherwise explicitly defined. Furthermore, it is to be noted that performing all phases of the flow charts is not mandatory.

The method of FIG. 3 provides an autoencoder model for the purpose of processing metrics of a target system and comprises following phases:

Phase 301: A data set is obtained. The data set comprises metrics associated with a target system and the data set is intended for training the autoencoder for processing further metrics of the target system.

The target system may be an industrial process or a communication network. The data set may comprise sensor data and/or performance metrics from the target system. For example, key performance indicators (KPI) relating to a communication network (such as signal levels, throughput, handover data, connection statistics), temperature, pressure, features of product samples or the like may be included in the data set.

Phase 302: The data set is masked with a predefined mask. The mask excludes or hides certain parts of the data set. The mask may exclude certain element of each individual entry of the data set. The mask may exclude one or more, but not all elements of each individual entry of the data set. That is, the mask excludes elements within each feature vector of the data set without excluding any full feature vector. The mask may be a regular or a random mask. The mask may be a regular or a random mask in the sense that the positions of elements are regularly or randomly arranged in the mask. In general, the mask is a defined pattern that is used for excluding data. That is, the mask may be a pattern defining positions of elements that are to be excluded. The mask may be a set of instructions defining which elements to exclude from each feature vector. As a simplified example, for a data set including three feature vectors each including six elements, an example mask may define that the third and fourth elements are excluded from the first feature vector, the first and fifth elements are excluded from the second feature vector, and the second and sixth elements are excluded from the third feature vector.

Phase 303: The unmasked parts of the data set are used for training the autoencoder. The autoencoder produces reconstructed data.

Phase 304: Reconstructed data from the autoencoder is masked with the same predefined mask. That is, data in corresponding locations is excluded in the original data set and in the reconstructed data set.

Phase 305: Reconstruction error of the unmasked parts of the reconstructed data is used to update parameters of the autoencoder. Thereby an autoencoder model is obtained.

Phase 306: The masked parts of the (original) data set are used for testing the auto encoder model.

Phase 307: The autoencoder model thus obtained is provided for processing further metrics of the target system. The autoencoder model may be used for the purpose of controlling the target system. Controlling may be based on anomaly detection performed using the autoencoder model.

In an embodiment, the method of FIG. 3 is used for performing autoencoder model selection by cross-validation. The cross-validation may be implemented by performing the method with k different predefined masks to obtain k different test sets and to perform k-fold cross-validation.

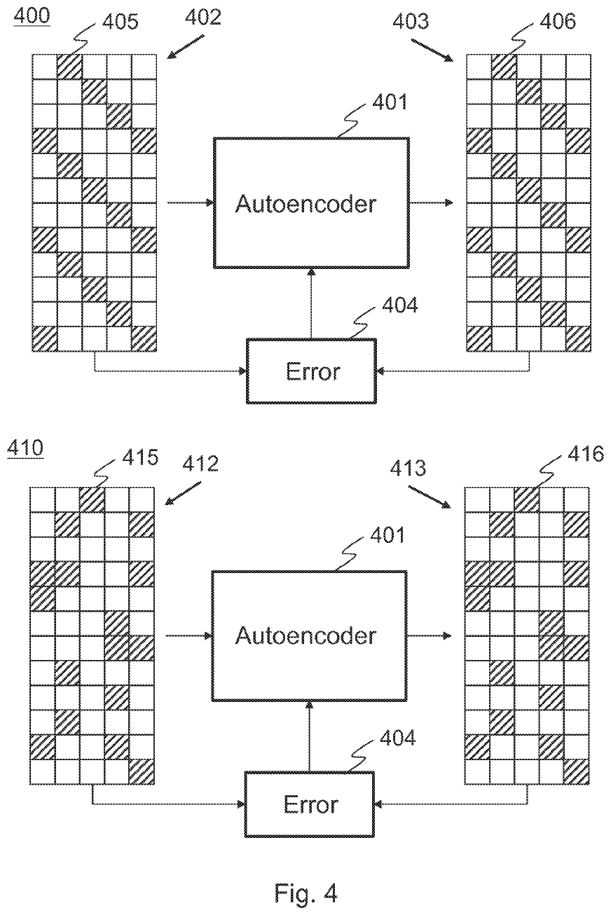

FIG. 4 illustrates some example implementations.

Example 400 comprises original data set 402, autoencoder 401 and reconstructed data set 403. The data sets are illustrated by grids, wherein each row represents one observation and each square represents one element or feature of the observation.

The original data set is masked with a mask that excludes the dashed squares 405. The mask is a regular mask in this example. The masked data set, i.e. the non-excluded elements, is then used for training the autoencoder 401. The autoencoder 401 provides the reconstructed data set 403, which is then masked with the same mask as the original data set. The dashed squares 406 are the masked elements of the reconstructed data set 403.

In block 404, reconstruction error is determined for the unmasked parts (or elements) of the reconstructed data set 403. The determined reconstruction errors are then used for updating autoencoder parameters by computing the gradient of the loss function with respect to the model parameters. A gradient-based optimization method is utilized to update the parameters. In this way the autoencoder 401 is trained purely on the non-masked elements.

As the masked elements 405 do not cause any activations within the autoencoder 401, the masked elements 405 of the original data 402 set are then usable for testing the autoencoder model to provide cross-validation of the autoencoder model.

The example 410 is similar with the example 400 except that different mask is used for masking the original data set 412, the reconstructed data set 413. The mask is a random mask in this example. That is, the locations of the elements that are masked by the mask in each row (each feature vector) have been randomly placed instead of using regular structure.

The dashed squares 415 are excluded from training the autoencoder 401 and the dashed squares 416 are the masked elements of the reconstructed data set 403.

In an embodiment of the invention, k different masks are used to achieve that each element of the original data set belongs to the test set in exactly one of the folds. By using the k different masks, k-fold cross-validation can be performed.

Example embodiments such as those illustrated in FIG. 4 are usable for optimizing hyperparameters of autoencoders. The hyperparameters to optimize include for example the following (non-exhaustive list):

Number and width of layers (including the latent layer),

Activation function type (e.g. sigmoid, hyperbolic tangent or rectifier),

Regularization weights, and

Optimizer and its parameters (e.g. learning rate)

Still further a hyperparameter to optimize with embodiments of the invention may be the probability of disabling a feature detector in the solution of US9406017.

In the following, some example use cases are discussed:

In a first example, a neural network (autoencoder) trained and evaluated according to method of some example embodiment is used in unsupervised anomaly detection. Embodiments of the invention may provide selection of hyperparameters of the unsupervised anomaly detection. In operation of complex systems such as communications networks or industrial (or manufacturing) processes or other target systems, unsupervised anomaly detection methods can be used to detect abnormal data points in performance or measurement metrics. For example, key performance indicators (KPI) relating to a communication network (such as signal levels, throughput, handover data, connection statistics), temperature, pressure, features of product samples or the like may be analysed. Detected abnormalities are then usable for management of the system to improve operation of the system and/or to avoid problems in operation of the system.

For example, multivariate time series data on batch manufacturing processes; multivariate time series data on continuous production processes; multivariate time series data on key performance indicators (KPI) relating to a communication network; and/or multivariate time series data on performance metrics of a cluster of cells in a communication network are analyzed. Unsupervised anomaly detection may be used to pinpoint variables that behave anomalously in comparison to previously seen production batches; to detect if behavior of the production process has changed and to indicate the variables associated with the change; to pinpoint changes in the relationships between KPIs of the communication network and to pinpoint the variables associated with those changes; and/or to pinpoint anomalies in metrics associated with clusters of cells. Management actions or changes in the manufacturing process or the communication network may then be targeted based on this information.

In a second example, a neural network is pretrained in an unsupervised manner for a supervised learning task. In the context of complex systems, there is often an abundance of unlabeled data, but obtaining labels requires effort from human experts, making the labeling process costly. In consequence, it would be beneficial to be able to use unlabeled data so that fewer labeled data points are required.

Having trained an autoencoder on the unlabeled data, the parameters of the encoder are used to initialize a neural network classifier. The labeled data may then be used to fine tune the parameters of the model so that it learns to discriminate between different fault situations in the target system. In an industrial (or manufacturing) process, the fault situations may include for example equipment failure or control system failure. In a communication network context, the fault situations may include for example antenna failure, configuration problems (e.g. in antenna tilt), congestion, coverage holes, interference, etc.

Embodiments of the invention may provide selection of hyperparameters of the autoencoder used for pretraining a neural network classifier. The labeled data may then be used to fine tune the neural network or to train some other model.

Without in any way limiting the scope, interpretation, or application of the claims appearing below, a technical effect of one or more of the example embodiments disclosed herein is that traditional cross-validation approach is extended to unsupervised learning problems associated with autoencoders.

Another technical effect of one or more of the example embodiments disclosed herein is providing a method that gives an estimate of the generalization error of the model when configured with each set of hyperparameters.

Yet another technical effect of one or more of the example embodiments is improved autoencoder that can be used for unsupervised anomaly detection used in management of industrial processes or communication networks or other target systems. Anomaly detection provides a possibility to obtain knowledge of variables that exhibit anomalous behavior in an anomalous data sample of a target system, whereby management of the target system can be improved. In this way educated actions can be taken in management of industrial processes and/or in management of communication networks. Additionally, targeting of the actions taken in the target system can be improved. As management actions may be improved, one may be able to save resources.

Yet another technical effect of one or more of the example embodiments is efficient use of data in the training phase. By performing data partitioning by excluding certain elements from each entry of the data set (i.e. from each feature vector) there is no need to reserve any full feature vector for validation and thereby most or even all elements of the data set can be used for training.

If desired, the different functions discussed herein may be performed in a different order and/or concurrently with each other. Furthermore, if desired, one or more of the before-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications, which may be made without departing from the scope of the present invention as defined in the appended claims.

1. A computer implemented method for obtaining an autoencoder model for the purpose of processing metrics of a target system, the method comprising:
obtaining a data set comprising metrics associated with the target system, the data set being intended for training the autoencoder for processing further metrics of the target system;
masking the data set with a predefined mask configured to exclude certain parts of the data set by excluding certain element of each individual entry of the data set;
using the unmasked parts of the data set for training the autoencoder;
masking reconstructed data from the autoencoder with the same predefined mask;
using reconstruction error of the unmasked parts of the reconstructed data to update parameters of the autoencoder to obtain autoencoder model;
using the masked parts of the data set for testing the autoencoder model; and
providing the autoencoder model for anomaly detection to detect abnormalities in performance or measurement metrics of the target system and for targeting management actions or changes in the target system based on the detected abnormalities.

2. The method of claim 1, wherein the target system is an industrial process).

3. The method of claim 2, wherein the data set comprises sensor data from the industrial process.

4. The method of claim 1, wherein the target system is a communication network.

5. The method of claim 4, wherein the data set comprises performance metrics from the communication network.

6. The method of claim 1, further comprising providing the autoencoder model for the purpose of controlling the target system.

7. The method of claim 1, wherein the predefined mask is a regular mask.

8. The method of claim 1, wherein the predefined mask is a random mask.

9. The method of claim 1 further comprising using the method for performing autoencoder model selection by cross-validation.

10. The method of claim 9, wherein using the method for performing autoencoder model selection by cross-validation comprises performing the method with k different predefined masks to perform k-fold cross-validation.

11. The method of claim 1 further comprising using the method for selecting hyperparameters for the autoencoder model.

12. An apparatus comprising:
a processor, and
a memory including computer program code; the memory and the computer program code configured to, with the processor, cause the apparatus to perform
obtaining a data set comprising metrics associated with the target system, the data set being intended for training the autoencoder for processing further metrics of the target system;
masking the data set with a predefined mask configured to exclude certain parts of the data set by excluding certain element of each individual entry of the data set;
using the unmasked parts of the data set for training the autoencoder;
masking reconstructed data from the autoencoder with the same predefined mask;
using reconstruction error of the unmasked parts of the reconstructed data to update parameters of the autoencoder to obtain autoencoder model;
using the masked parts of the data set for testing the autoencoder model; and
providing the autoencoder model for anomaly detection to detect abnormalities in performance or measurement metrics of the target system and for targeting management actions or changes in the target system based on the detected abnormalities.

13. A computer program product comprising a non-transitory memory medium with computer executable program code which when executed by a processor causes an apparatus to perform
obtaining a data set comprising metrics associated with the target system, the data set being intended for training the autoencoder for processing further metrics of the target system;
masking the data set with a predefined mask configured to exclude certain parts of the data set by excluding certain element of each individual entry of the data set
using the unmasked parts of the data set for training the autoencoder;
masking reconstructed data from the autoencoder with the same predefined mask;
using reconstruction error of the unmasked parts of the reconstructed data to update parameters of the autoencoder to obtain autoencoder model;
using the masked parts of the data set for testing the autoencoder model; and
providing the autoencoder model for anomaly detection to detect abnormalities in performance or measurement metrics of the target system and for targeting management actions or changes in the target system based on the detected abnormalities.

14. The apparatus of claim 12, wherein the memory and the computer program code are further configured to, with the processor, cause the apparatus to perform providing the autoencoder model for the purpose of controlling the target system.

15. The apparatus of claim 12, wherein the memory and the computer program code are further configured to, with the processor, cause the apparatus to perform autoencoder model selection by cross-validation.

16. The apparatus of claim 12, wherein the memory and the computer program code are further configured to, with the processor, cause the apparatus to perform selecting hyperparameters for the autoencoder model.
